(19) United States
(12) Patent Application Publication
(10) Pub. No.: US 2014/0235387 A1
(43) Pub. Date: Aug. 21, 2014

(54) ACTIVE TENSIONING DEVICE

(71) Applicant: ALTEX DECORATION LIMITÉE, Terrebonne (CA)

(72) Inventors: Giovanni BERGAMASCHI, Bologna (IT); Isabelle BOLDUC, Sherbrooke (CA); Bruno ARCHAMBAULT, Sherbrooke (CA)

(73) Assignee: ALTEX DECORATION LIMITÉE, Terrebonne (CA)

(21) Appl. No.: 14/182,510

(22) Filed: Feb. 18, 2014

Related U.S. Application Data
(60) Provisional application No. 61/765,270, filed on Feb. 15, 2013.

(51) Int. Cl. F16H 7/08

(52) U.S. Cl. CPC F16H 7/08
USPC 474/112

(57) ABSTRACT

An active tensioning device for a looped cord of a window covering system. The active tensioning device comprises a body having a channel configured to receive a section of the looped cord therein. The channel has a first wall allowing the section of the looped cord to slide thereon and a second wall having at least one cord engaging member engageable with the section of the looped cord. The active tensioning device is pivotable about the looped cord between an inoperative configuration where the looped cord contacts the second wall of the channel and an operative configuration where the looped cord contacts the first wall of the channel. The active tensioning device is balanced to be urged towards the inoperative configuration by gravity.

### CROSS-REFERENCE TO RELATED APPLICATION

This application claims the benefit of U.S. Provisional Patent Application Ser. No. 61/765,270 filed Feb. 15, 2013, the entirety of which is hereby incorporated herein by reference for all purposes.

### FIELD OF THE INVENTION

The present invention relates to the field of window coverings. More particularly, it relates to an active tensioning device for a looped cord of a window covering system.

### BACKGROUND

It is common for window covering systems to include a continuous or jointed looped cord as controlling member, for a user to operate the window covering system. Window covering systems including such a looped cord are often referred to as endless cord drive systems, where a user actuates or rotates the looped cord in one direction to raise (or open) the shading elements and actuates or rotates the looped cord in an opposite direction to lower (or close) the shading elements.

One of the major drawbacks of such endless cord drive systems is that, to be easily operable by a user, the looped cord often extends downward such that it can be within the reach of children or toddlers. In such cases, the looped cord can pose important security issues, as it can cause entanglement and even strangulation of a child playing with the looped cord. To address this issue, many countries have enacted regulations requiring that endless cord drive window covering systems be provided with a tensioning device that holds the looped cord in a tensioned configuration and therefore reduces the associated security hazards.

For example and without being limitative, numerous tensioning devices (also known as tie down devices) attachable to a structure, such as a wall or a window frame, to maintain the cord in a tensioned configuration, are known in the art. These tensioning devices often include a pulley, around which a bottom section of the looped cord travels, to allow the looped cord to displace or rotate freely thereabout when operated by a user for raising (or opening) or lowering (or closing) the shading element. However, in many cases, these devices allow the looped cord to be operated even if the tensioning device has not been attached to the structure. Consequently many users do not take the time to attach the tensioning device to the structure, which results in the tensioning device not fulfilling its security purpose.

To alleviate this problem, numerous active tensioning devices have been proposed where the looped cord is prevented from being operated properly, unless the tensioning device is installed appropriately and maintains the looped cord in a tensioned configuration. Regulations requiring manufacturers to provide such active tensioning devices for endless cord drive window covering systems are also being enacted in different countries.

Known active tensioning devices however tend to present several drawbacks. In many cases, the proposed active tensioning devices are unaesthetic as a result of the moving parts required for preventing the looped cord to be operated properly when the device is not attached to a structure. Moreover, known active tensioning devices include mechanical components such as resilient members, screws and/or other types of moving parts, which contribute to increase the manufacturing and assembly costs of the devices, as well as the risks of breakage and/or malfunction during use.

In view of the above, there is a need for an improved active tensioning device which, by virtue of its design and components, would be able to overcome or at least minimize some of the above-discussed prior art concerns.

### SUMMARY OF THE INVENTION

According to a first general aspect, there is provided an active tensioning device for a looped cord of a window covering system. The active tensioning device comprises a body having a channel configured to receive a section of the looped cord therein. The channel being formed between a first wall allowing the section of the looped cord to slide thereon and a second wall having at least one cord engaging member engageable with the section of the looped cord. The active tensioning device is displaceable with respect to the looped cord between an inoperative configuration where the looped cord contacts the second wall of the channel and an operative configuration where the looped cord contacts the first wall of the channel. The active tensioning device is balanced to be urged towards the inoperative configuration by gravity.

In an embodiment, the active tensioning mechanism further comprises a fixation member connectable to the body. The fixation member is securable to a structure for maintaining the body in the operative configuration.

In an embodiment, the active tensioning mechanism comprises a plurality of fixation members adaptable to a plurality of structural interfaces. Each one of the plurality of fixation members is connectable to the body of the active tensioning device.

In an embodiment, the body of the active tensioning device comprises two symmetrical interlocking sections.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of an active tensioning device in combination with an endless cord in accordance with an embodiment, the active tensioning device being shown in the operative configuration.

FIG. 2 is a perspective view of the active tensioning device of FIG. 1 in combination with an endless cord, the active tensioning device being shown in the inoperative configuration.

FIG. 3 is a side elevation view of the active tensioning device of FIG. 1.

FIG. 4 is a perspective view of an inner face of a section of the body of the active tensioning device of FIG. 1.

FIG. 5 is a perspective view of an outer face of the section of the body of the active tensioning device of FIG. 4.

FIG. 6 is a perspective view of a compact fixation member of the active tensioning device, according to an embodiment.

FIG. 7 is a perspective view of an elongated fixation member of the active tensioning device, according to an embodiment.

FIG. 8 is a perspective view of an angled fixation member of the active tensioning device, according to an embodiment.

FIG. 9 is a perspective view of an active tensioning device, according to an embodiment where the elongated fixation member of FIG. 7 is provided.

FIG. 10 is a perspective view of a cap cover of the active tensioning device, according to an embodiment.

FIG. 11A is a perspective view of an inner face of a section of the body of an active tensioning device, according to an embodiment where two void sections are provided in the body of the tensioning device.

FIG. 11B is a perspective view of an outer face of a section of the body of the active tensioning device of FIG. 11A.

FIG. 11C is a perspective view of a section of a fixation member, according to an embodiment where the fixation member is formed of two interlockable sections.

FIG. 11D is a perspective view of the fixation member of FIG. 11C mounted to the body of an active tensioning device.

### DETAILED DESCRIPTION

In the following description, the same numerical references refer to similar elements. The embodiments, geometrical configurations, materials mentioned and/or dimensions shown in the figures or described in the present description are preferred embodiments only, given solely for exemplification purposes.

Moreover, although the embodiments of the active tensioning device and corresponding parts thereof consist of certain geometrical configurations as explained and illustrated herein, not all of these components and geometries are essential to the invention and thus should not be taken in their restrictive sense. It is to be understood, as also apparent to a person skilled in the art, that other suitable components and cooperation thereinbetween, as well as other suitable geometrical configurations, may be used for the active tensioning device, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

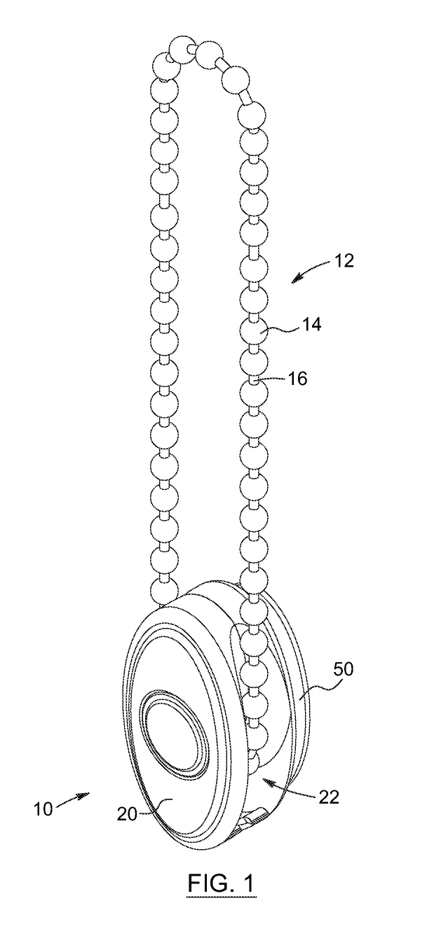

Referring generally to FIGS. 1 to 3, in accordance with one embodiment, there is provided an active tensioning device 10 for a window covering system (not shown) having a continuous or jointed looped cord 12 as controlling member. The active tensioning device 10 can be used in combination with any type of window covering system with a looped cord, such as, for example an horizontal blind system, a vertical blind system, a roller shade system or the like.

In the illustrated embodiment, the looped cord 12 is a ball chain cord where beads 14 or stops are interconnected directly to each other or are mounted on a common thread 16. One skilled in the art will however understand that in alternative embodiments, the cord 12 can be of other types. For example and without being limitative, the cord 12 could be a rope, a single or multi-filament thread, a wire, a twine, or another type of chain.

The active tensioning device 10 includes a body 20 with a channel 22 configured to receive a section of the looped cord 12 therein. The body 20 can be made of any material offering sufficient sturdiness to allow the tensioning device 10 to engage the bottom section of the looped cord 12 and maintain the looped cord 12 tensioned, when configured in the operative configuration, as will be described below. For example and without being limitative, the body 20 may be made of moulded plastic such as acrylonitrile butadiene styrene (ABS), polycarbonate, and/or acrylic. Other materials offering similar characteristics could also be used in the construction of the body 20.

The channel 22 formed in the body 20 is bordered on a first side by a first wall 24 and on a second side by a second wall 28. The first wall 24 and the second wall 28 are connected together by connecting walls 26 spaced apart from one another. The first wall 24 is a smooth wall allowing the looped cord 12 to slide thereon, without hindering the movement of the looped cord 12 thereabout. The second wall 28 has at least one cord engaging member 30 which engages the looped cord 12.

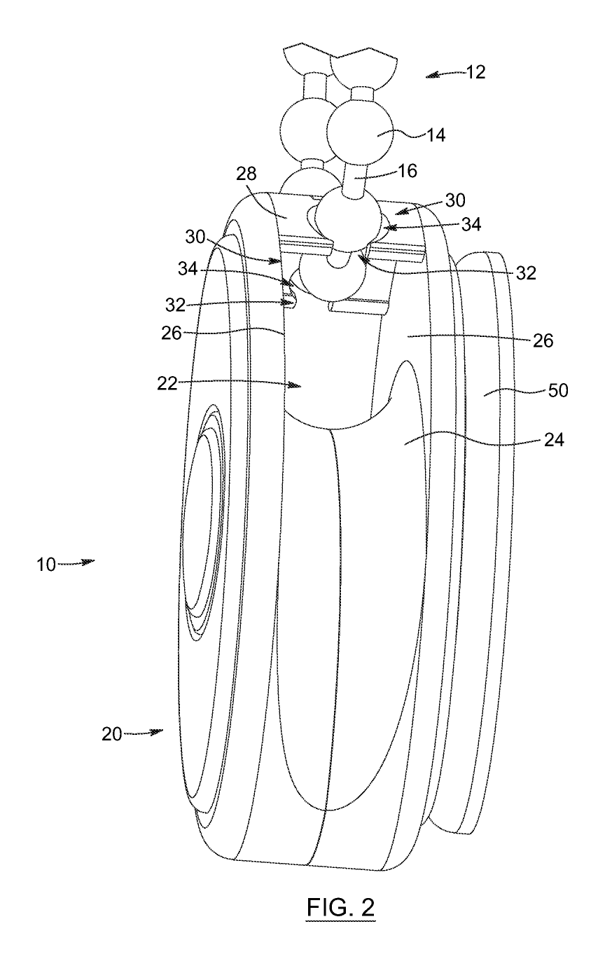

When a looped cord 12 is provided within the channel 22 formed in the body 20 of the active tensioning device 10, the body 20 is positionable or pivotable about the looped cord 12 between an operative configuration (shown in FIG. 1) and an inoperative configuration (shown in FIG. 2).

As can be seen in FIG. 1, in the operative configuration, the bottom section of the looped cord 12 contacts the first wall 24 of the channel 22, as it goes around a section of the body 20 of the tensioning device 10. In such a configuration, the tensioning device 10 allows the looped cord 12 to be maintained in a tensioned state between the window covering system (not shown) contacting a top section of the looped cord 12 and the tensioning device 10 contacting the bottom section of the looped cord 12. Given that the first wall 24 of the channel 22 is smooth, the looped cord 12 can be freely rotated for operating the window covering system.

As can be seen in FIG. 2, in the inoperative configuration, the bottom section of the looped cord 12 contacts the second wall 28 of the channel 22, as it goes around a section of the body 20 of the tensioning device 10. In such a configuration, the at least one cord engaging member 30 of the second wall 28 engages the bottom section of the looped cord 12. Therefore, when the looped cord 12 is subsequently actuated by a user, in an attempt to operate the window covering system (not shown), the tensioning device 10 will displace along with the engaged section of looped cord 12 and will consequently prevent the window covering system to be operated properly as it will eventually come into contact with the mechanism of the window covering system, thereby preventing further actuation or displacement of the looped cord 12.

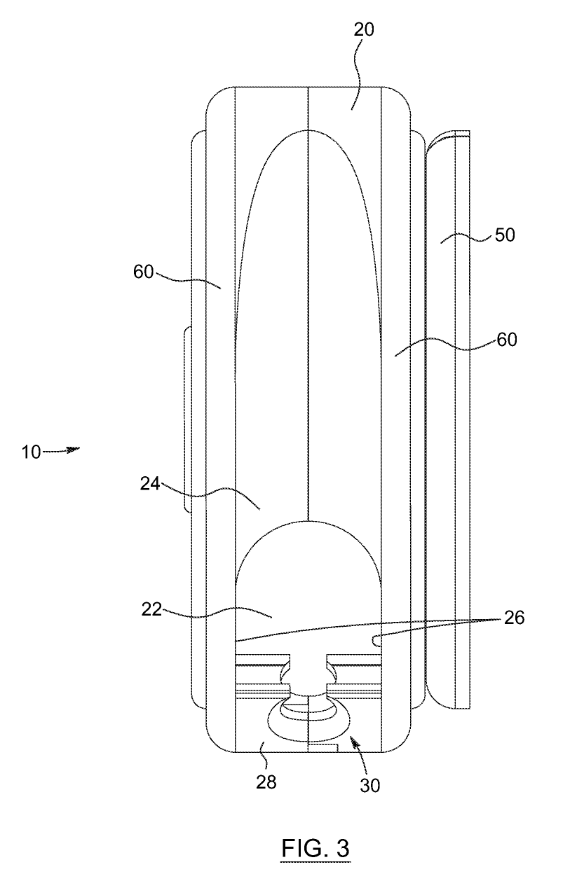

Now referring to FIGS. 2 and 3, in the illustrated embodiment, the second wall 28 includes a cord engaging member 30 at each one of its extremities. Each cord engaging member 30 forms an aperture in the second wall 28 having a neck 32 wide enough to allow the passage of the thread 16 of the ball chain looped cord 12 and a head 34 with a diameter smaller than the beads 14 of the corresponding ball chain looped cord 12, such that when the thread 16 of the ball chain looped cord 12 enters the cord engaging member 30, the adjacent beads 14 engage the second wall 28 and prevent displacement of the cord 12 with respect to the second wall of the channel 22 of the body 20. In other words, each cord engaging member 30 acts as a hook for engaging a bead 14 of the looped cord 12. It will be understood that, in an alternative embodiment, a cord engaging member 30 could be provided only at one of the extremities of the second wall 28. Moreover, different types of cord engaging members could be provided. For example and without being limitative, the cord engaging member 30 could be provided without a neck 32.

In another alternative embodiment where the looped cord 12 is not a ball chain cord, other configurations could be provided for the cord engaging member 30, the only requirement being that the cord engaging member 30 engages the cord 12 to prevent displacement of the cord 12 with respect to the second wall 28. For example and without being limitative, a tapered and cord-engaging void section could be provided to frictionally engage the cord 12.

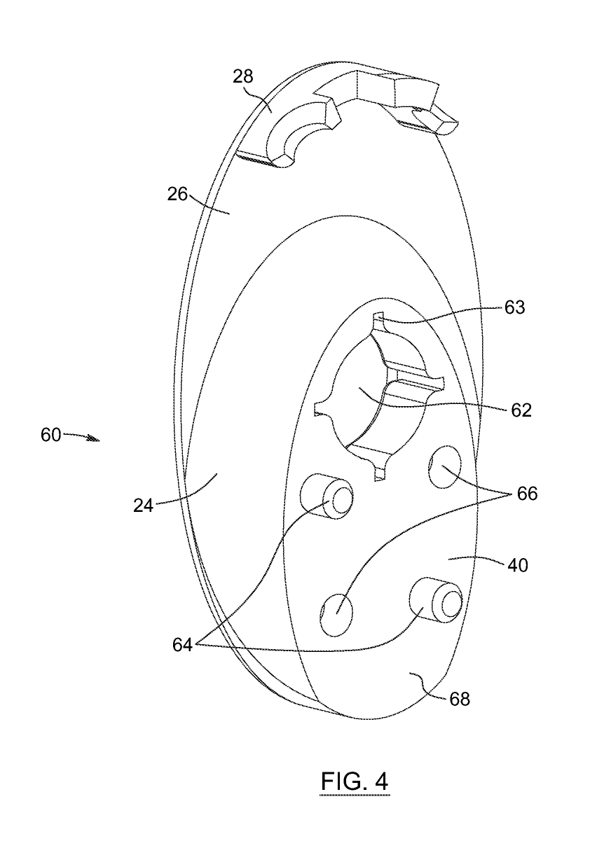

In order to provide an active tensioning device 10 where the window covering system is prevented from being operated, unless the tensioning device 10 has been installed properly, the tensioning device 10 is balanced such that it is urged towards the inoperative configuration by gravity. Such a balancing of the active tensioning device 10 results from the center of gravity of the body 20 of the tensioning device 10 being located away from the second wall 28, i.e. a majority of the weight of the active tensioning device 10 is distributed away from the second wall 28. In the Illustrated embodiment of FIG. 1, where the active tensioning device 10 is shown in the operative configuration, the majority of the weight is found in the balancing section 40 (shown in FIG. 4), over the first wall 24, and mostly towards the top, such that, the center of gravity is sufficiently over the first wall 24 to balance the body 20 of the device 10 towards the inactive configuration shown in FIG. 2. In other words, the position of the center of gravity is such that unless the active tensioning device 10 is maintained in the operative configuration by external forces, the active tensioning device 10 will displace or rotate naturally towards the inactive configuration shown in FIG. 2. The rounded or curved configuration of the first wall 24 facilitates the natural transition between the operative configuration and the inoperative configuration.

In an embodiment, an offset mass element (not shown) is positioned in the balancing section 40 in order to provide such a balancing.

Therefore, when a window covering system having a looped cord 12 and an active tensioning device 10 such as the one described herein is initially installed, the active tensioning device 10 is naturally moved to the inoperative configuration at the bottom of the looped cord 12 by gravity. Given that the window covering system cannot be operated properly when the active tensioning device 10 is in the inoperative configuration, as previously explained, users are compelled to manually position the tensioning device 10 in the operative configuration, and affix the tensioning device 10 to a structure such that it is maintained in this operative configuration, before the window covering system can be operated efficiently. Different mounting methods or techniques can be used to affix the tensioning device 10 to a structure. For example and without being limitative, the tensioning device 10 could be directly bonded, nailed or screwed to the surface. As will be described later, in an embodiment, the active tensioning device 10 includes a fixation member connected to the body 20 of the active tensioning device 10 to be easily affixed to an adjacent structure by a user.

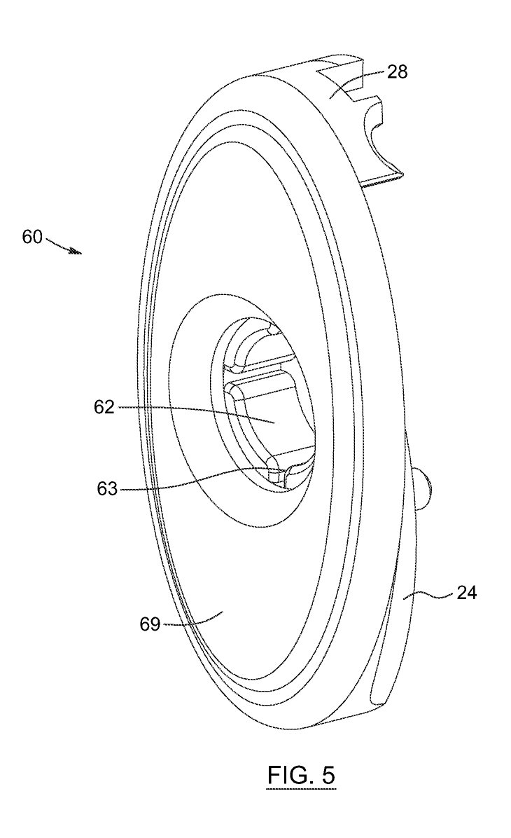

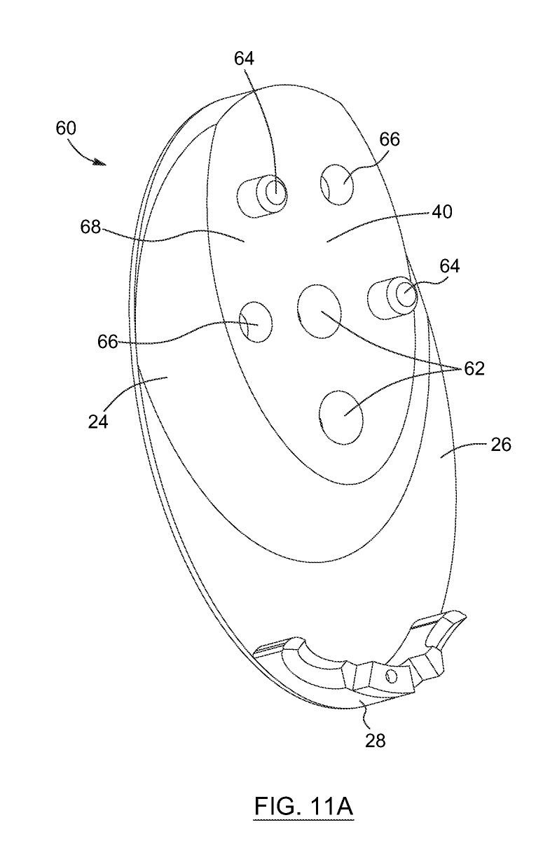

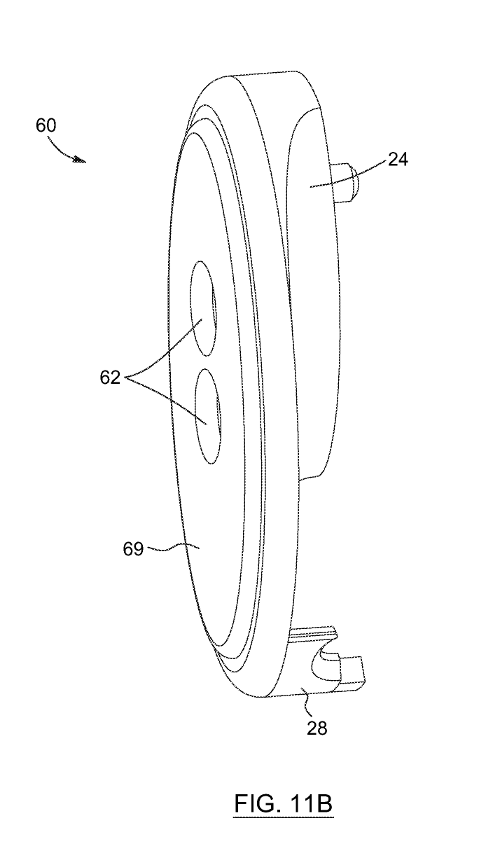

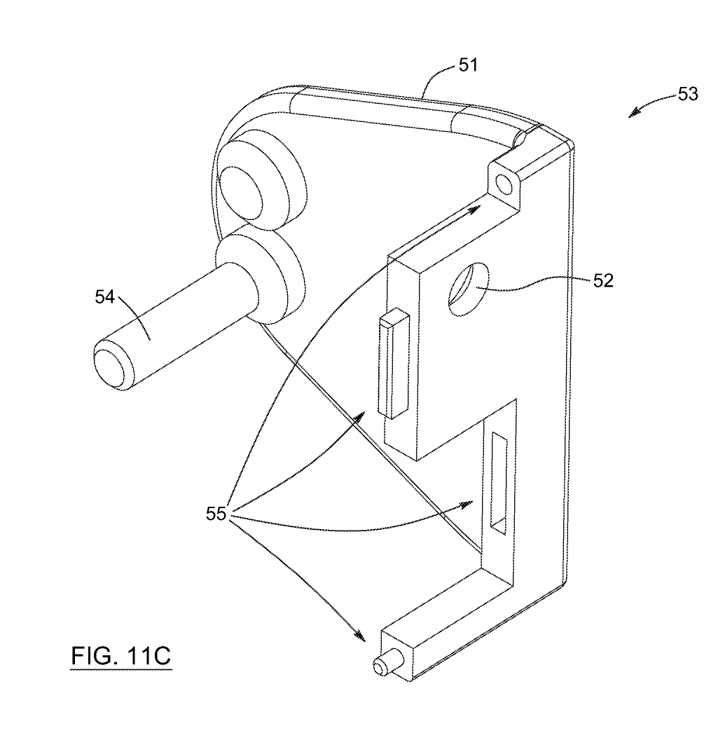

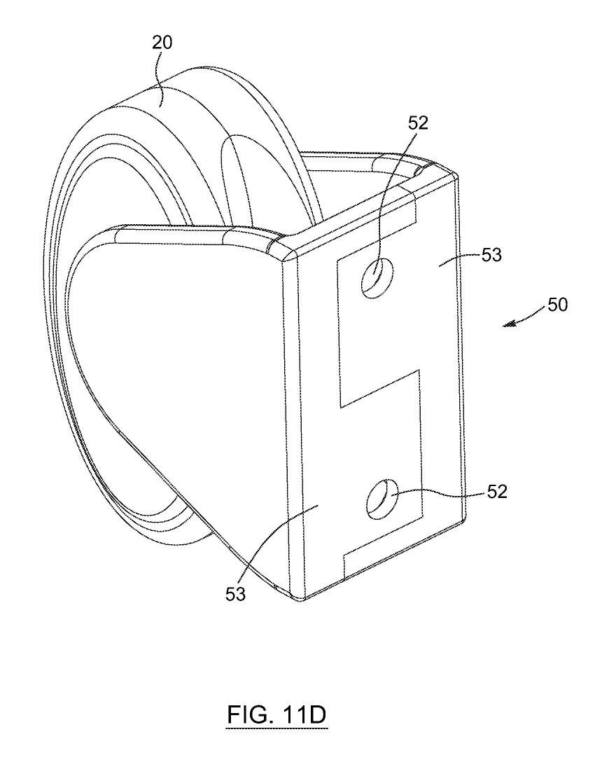

Now referring to FIGS. 3 to 5, 11A and 11B, in an embodiment, the body 20 of the active tensioning device 10 is composed of two symmetrical interlocking pieces forming a section 60 of the body. In the illustrated embodiments, each section 60 includes a portion of the second wall 28, a portion of the first wall 24, a portion of the balancing section 40 and a connecting wall 26 connecting the portion of the first wall 24 and the portion of the second wall 28. A pattern of connecting pins 64 projecting from the inner face 68 of the section 60, along the balancing section 40, and connecting holes 66 extending into the inner face 68 of the section 60, within the balancing section 40 as well, is also provided. In the embodiment shown in FIGS. 4 and 5 a through hole extends through the balancing section 40 of the body 20 and forms a void section 62 therein. In the embodiment shown in FIGS. 11A and 11B, two through holes extend through the balancing section 40 of the body 20 and form two void sections 62 therein. The two void sections 62 may be used to directly affix the body to a structure, using fixating means, or to connect a fixation member thereto, as will be described later.

One skilled in the art will understand that in alternative embodiments, the sections 60 of the body 20 could present a different design or configuration than the one illustrated in FIGS. 3 to 5, 11A and 11B.

In the illustrated embodiments of FIGS. 3 to 5, 11A and 11B, each section 60 is designed such that it is symmetrical in order to allow identical pieces to be interlocked with one another when brought in a configuration where the inner faces of each section 60 face each other. Consequently, in order to form the body 20 of the active tensioning device 10, two sections 60 are interlocked in the previously mentioned configuration where the inner faces of each section 60 face each other. The symmetry of the sections 60 ensures that the sections 60 mate properly with one another to form the body 20 and the complementary connecting pins 64 and connecting holes 66 further ensure the proper alignment of the sections 60 with one another.

The use of two symmetrical interlocking sections 60 such as the one described above allows the body 20 of the active tensioning device 10 to be manufactured at a low production cost, since a single mold can be used to produce a single design of sections 60. The produced sections 60 can subsequently be paired, each pair of sections 60 being interlocked to form the body 20 of the tensioning device 10. It will be noted that the pair of sections 60 can be assembled with one another without the use of any additional mechanical component, the sections simply being friction or press fitted with one another to allow the body to be easily assembled or taken apart if necessary.

Even though the use of symmetrical interlocking sections may be advantageous, in alternative embodiments, the body 20 of the active tensioning device 10 may be formed of asymmetrical sections or be manufactured as a single one-piece component.

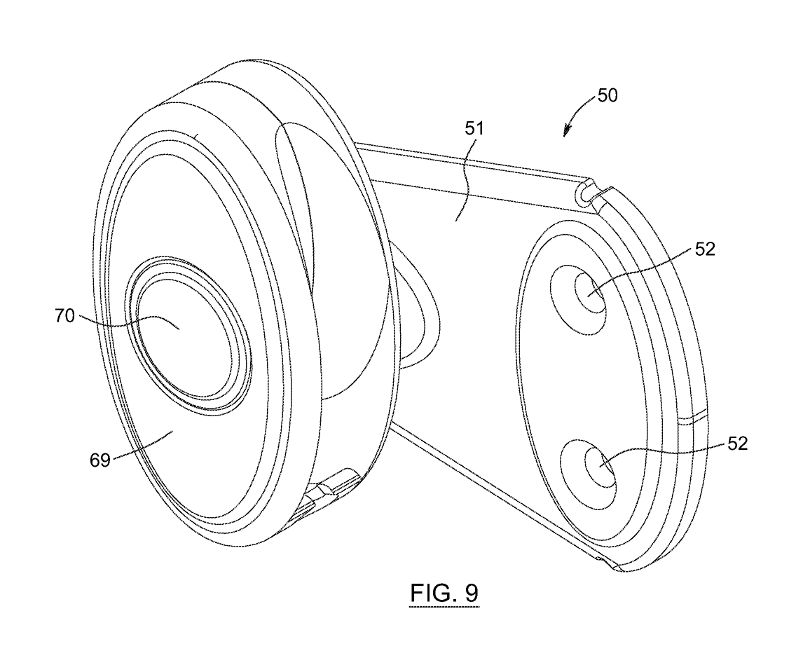

In an embodiment, the active tensioning device 10 includes a fixation member 50 to be easily affixed by a user to an adjacent structure. For example and without being limitative, active tensioning devices 10 with a fixation member 50 are shown in FIGS. 1, 2, 3, 9 and 11D.

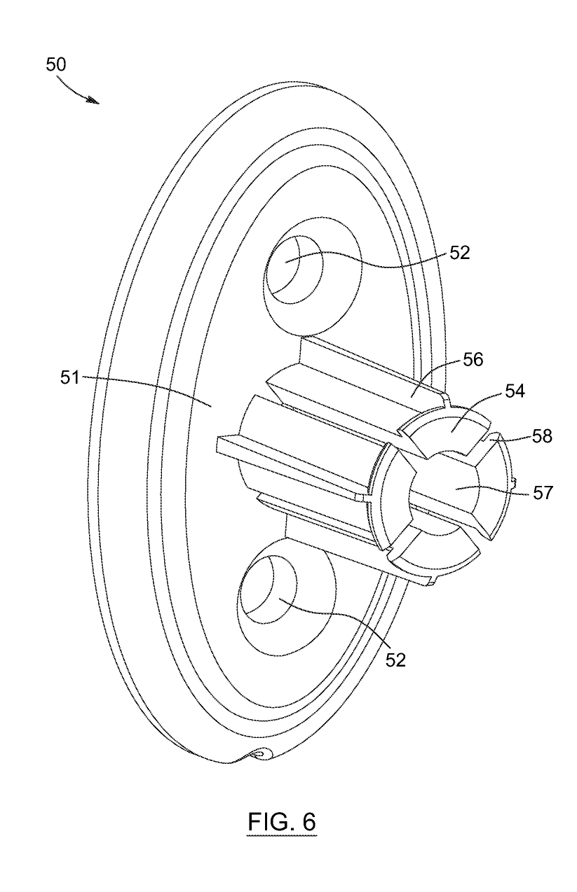

As can easily be seen in FIGS. 6 to 8, in the illustrated embodiments, each fixation member 50 has a frame 51 with a connecting member 54 extending therefrom and screw holes 52 formed therein. It will be understood that the term “screw hole” is used herein to refer to a hole formed in the frame 51 to allow the passage of a section of a mechanical fastener, such as a screw, but that other mechanical fasteners could be used in connection with the screw holes 52. For example and without being limitative, nails could be used in connection with the screw holes 52.

In the illustrated embodiment of FIGS. 4 to 8, the connecting member 54 is a male member projecting from the frame 51 of the fixation member 50. The connecting member 54 is complementary in shape and size to the through hole forming the void section 62 in the the body 20 and therefore allows the fixation member 50 to be connected to the body 20 of the tensioning device 10 by simply connecting the connecting member 54 of the fixation member 50 and the void section 62 of the body 20 in a male-female configuration. In order to maintain the angular position between the body 20 and the fixation member 50, in the illustrated embodiment, the connecting member 54 and the void section 62 are provided with complementary flanges 56 extending radially along the length of the connecting member 54 and radial slots 63 formed in the wall of the void section 62. Therefore, after the connecting member 54 has been inserted into the void section 62, the fixation member 50 cannot displace itself or rotate about the body 20. A person skilled in the art would however understand that other design or method for preventing movement or angular rotation between the fixation member 50 and the body 20 could be provided. For example and without being limitative, the flanges and slots could be inverted between the connecting member 54 and the void section 62, or a simple friction or press fit between the connecting member 54 and the void section 62 could be provided.

Referring to FIGS. 11A to 11D, in an embodiment, the fixation member 50 may be formed of two symmetrical interlocking sections 53. Each section has a frame 51 with a connecting member 54 extending therefrom and screw holes 52 formed therein. When assembled to form the fixation member 50, as shown in FIG. 11D, the two symmetrical interlocking sections 53 are interlocked with one another to form a unitary frame where the connecting members 54 extend inwardly from opposite directions. Each one of the connecting members 54 is complementary in shape and size to one of the through holes forming the void sections 62 in the balancing section 40 of the body 20. Therefore, the fixation member 50 is connected to the body 20 of the tensioning device 10 by sliding the connecting members 54 into the void sections 62 of the body 20, from opposite faces, in a male-female configuration. Male-female members may also be provided along mating junctions 55 to provide a solid interlock.

Once again, even though the use of symmetrical interlocking sections may be advantageous, in alternative embodiments, the fixation member 50 may be formed of asymmetrical sections.

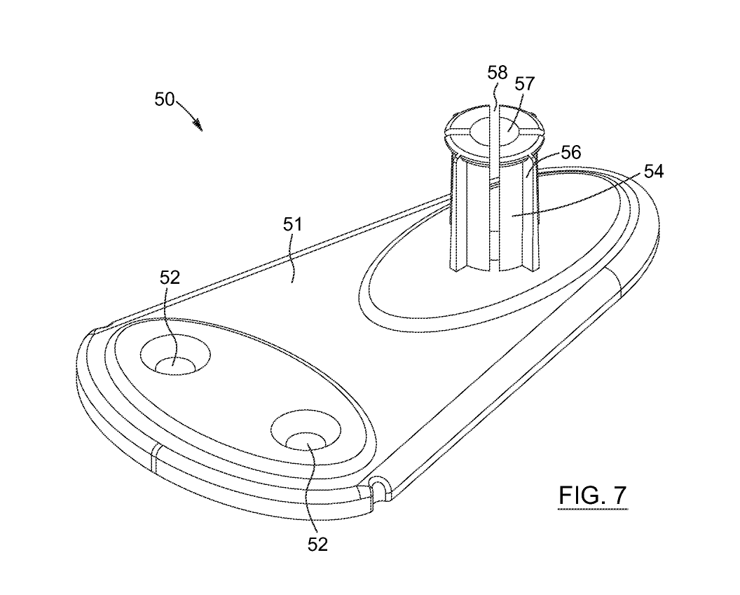

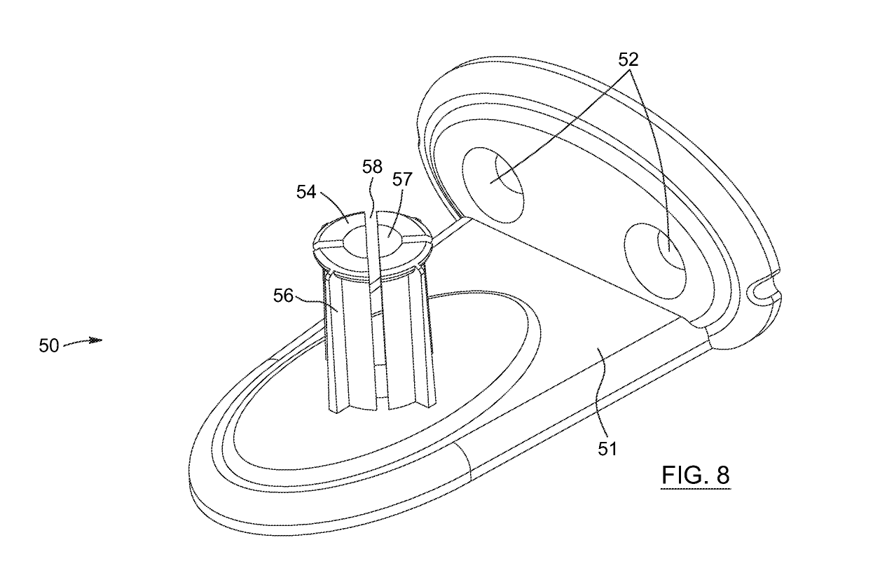

Referring to FIGS. 6 to 8, 11C and 11D, the frame 51 of the fixation member 50 can present different shapes. As can be seen in FIG. 6, the frame 51 can present a compact shape where the connecting member 54 and the screw holes 52 are located along the same plane and proximate to one another, in a configuration where the connecting member 54 is between the screw holes 52. In the embodiment of FIG. 7, the frame 51 has an elongated shape that allows the connecting member 54 and the screw holes 52 to still be located along the same plane, but to be distal from one another. In the embodiment of FIG. 8, the frame 51 has an angled shape where the connecting member 54 and the screw holes 52 are found on sections of the frame 51 that are angled relative to one another. In the illustrated embodiment, the sections mark approximately a 90° angle between one another, but one skilled in the art will understand that other angular configurations could be provided. In the embodiment of FIGS. 11C and 11D, the frame 51 of the combined sections 53 forming the fixation member 50 is “U” shaped. Therefore the connecting members 54 engage the body 20 of the tensioning device 10 from opposite faces in a solid assembly. In this embodiment, the connecting members 54 and the screw holes 52 are also found on sections of the frame 51 that are angled relative to one another.

The diversity of the design of the fixation member 50 provides versatility for the active tensioning device 10, by allowing the body 20 to be combined to a fixation member 50 that is appropriate for the structure to which the active tensioning device 10 is to be affixed. As a result, the active tensioning device 10 can be affixed in many different positions and to many different structures easily and without resulting in a crossing of the looped cord 12.

For example, the fixation member of FIG. 8 may be appropriate for mounting the active tensioning device 10 to the bottom of a window frame, while the fixation member of FIGS. 6,7 and 11D is more appropriate for mounting the active tensioning device 10 to a wall or the side of a window frame. In an embodiment, numerous fixation members 50 may be provided along with the body 20 of the active tensioning device 10 for a user to select the appropriate fixation member 50 and connect it with the body 20. One skilled in the art will understand that other configurations than the one illustrated herein could also be provided for the fixation members 50, thereby resulting in further versatility.

Moreover, in certain circumstances the fixation member 50 can be connected to the body 20 of the active tensioning device 10 before being attached to the structure or after being attached thereon. Connection of the fixation member 50 to the body 20 of the active tensioning device 10 after being attached to the structure is particularly relevant when the frame 51 presents a compact shape, as shown in FIG. 6 and as shown connected to the body 20 of the active tensioning device 10 in FIGS. 1 to 3, since the body 20 of the active tensioning device 10 covers the screw holes 52 when connected with the fixation member 50. In the embodiment shown in FIG. 11D, a first section 53 of the fixation member 50 may be attached to the structure before being connected to the body 20 of the active tensioning device 10, and a second section 53 may be attached to the structure after the sections 53 have been connected to the body and interlocked with one another.

In an embodiment, the connecting member 50 should be connected to the body 20 of the active tensioning device 10 only once the active tensioning device 10 has been moved to the operative configuration, such that the connecting member does not create an undesirable imbalance of the body 20 of the active tensioning device 10. Therefore, in an embodiment, the active tensioning device is initially provided without such a connecting member 50. The connecting member 50 should be connected with the active tensioning device 10 only once a user has positioned the active tensioning device 10 in the operative configuration and either has attached the active tensioning device 10 to a structure or is about to do so.

In the embodiment of FIG. 11D, since the closure formed by the connecting member 50 would hinder the movement of the active tensioning device 10 between the active configuration and the inactive configuration, therefore defeating the purpose of the active tensioning device 10, the active tensioning device 10 should initially be provided without such a connecting member 50.

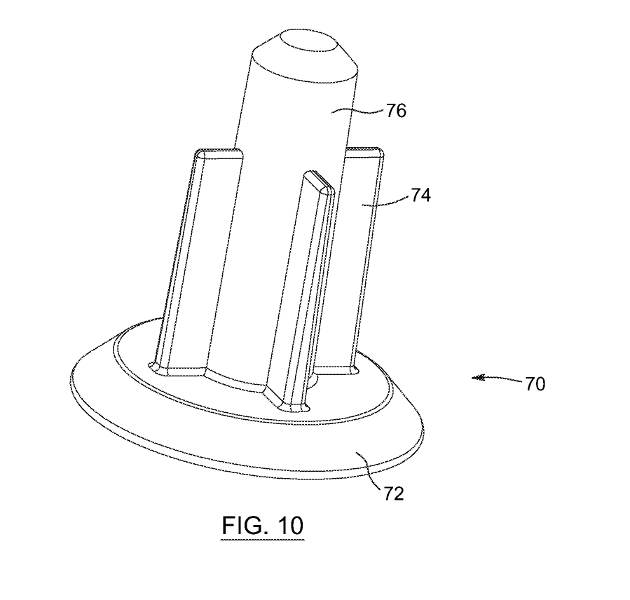

Finally, as can better be seen in FIGS. 5, 9 and 10, in the embodiments where the fixation member 50 is connected only on one face of the body, a cap cover 70 may be provided for covering the void section 62, on the outer face 69 of the body 20 opposite to the one proximate to the fixation member 50. The cap cover 70 includes a head 72 for closing the void section 62 and a projecting member 76 projecting therefrom. The cap cover 70 may also comprise flanges 74 extending radially along the length of the projecting member 76. The main purpose of the cap cover 70 is to lock the connecting member 54 of the fixation member 50 into place.

Referring to FIGS. 6 to 10, when the cap cover 70 is mounted on the active tensioning device 10, the projecting member 76 is inserted into a void section 57 formed in the connecting member 54 of the fixation member 50 previously inserted into the void section 62 of the body 20. The flanges 74 of the projecting member 76 are inserted into complementary slits 58 formed in the connecting member 54 of the fixation member 50, thereby increasing the friction between the connecting member 54 of the fixation member 50 and the wall surrounding the void section 62 of the body 20 of the device 10.

One skilled in the art will understand that in an embodiment where no fixation member 50 is provided, complementary cap covers could be inserted into the void section 62 from the opposed outer faces 69 of the body 20.

As can be understood from the above description, the active tensioning device 10 described above includes no mechanical components such as resilient members, screws and/or other moving parts to provide the active tensioning capabilities of the mechanism. Only the fixation of the device 10 onto the structure requires fixating means such as screws or nails.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. An active tensioning device for a looped cord of a window covering system, the active tensioning device comprising:
a body having a channel configured to receive a section of the looped cord therein, the channel being formed between;
a first wall allowing the section of the looped cord to slide thereon; and
a second wall having at least one cord engaging member engageable with the section of the looped cord;
wherein the active tensioning device is displaceable with respect to the looped cord between an inoperative configuration where the looped cord contacts the second wall of the channel and an operative configuration where the looped cord contacts the first wall of the channel, the active tensioning device being balanced to be urged to the inoperative configuration by gravity.

2. The active tensioning device of claim 1, wherein the active tensioning device is pivotable about the looped cord

3. The active tensioning device of claim 1, further comprising a fixation member connectable to the body, the fixation member being securable to a structure for maintaining the body in the operative configuration.

4. The active tensioning device of claim 2, further comprising a fixation member connectable to the body, the fixation member being securable to a structure for maintaining the body in the operative configuration.

5. The active tensioning device of claim 3, comprising a plurality of fixation members adaptable to a plurality of structural interfaces, each one of the plurality of fixation members being connectable to the body of the active tensioning device.

6. The active tensioning device of claim 4, comprising a plurality of fixation members adaptable to a plurality of structural interfaces, each one of the plurality of fixation members being connectable to the body of the active tensioning device.

7. The active tensioning device of claim 1, wherein the body of the active tensioning device comprises two symmetrical interlocking sections.

8. The active tensioning device of claim 3, wherein the body of the active tensioning device comprises two symmetrical interlocking sections.

9. The active tensioning device of claim 1, wherein the first wall is curved.

10. The active tensioning device of claim 3, wherein the first wall is curved.

11. The active tensioning device of claim 1, further comprising an offset mass element for offsetting a center of gravity of the active tensioning device to further urge the active tensioning device to the inoperative configuration by gravity.

12. The active tensioning device of claim 3, further comprising an offset mass element for offsetting a center of gravity of the active tensioning device to further urge the active tensioning device to the inoperative configuration by gravity.

13. The active tensioning device of claim 3, wherein the body comprises one of a male or female connecting member and the fixation member comprises the other of a male or female connecting member for removable connection between the body and the fixation member.

14. The active tensioning device of claim 4, wherein the body comprises one of a male or female connecting member and the fixation member comprises the other of a male or female connecting member for removable connection between the body and the fixation member.

15. The active tensioning device of claim 13, the male and female connecting members are shaped to prevent rotation between the body and the fixation member once the male and female connecting members are connected together.

16. The active tensioning device of claim 14, the male and female connecting members are shaped to prevent rotation between the body and the fixation member once the male and female connecting members are connected together.

17. The active tensioning device of claim 13, the male and female connecting members are configured such that the body and the fixation member are only connectable when the body is in the operative configuration.

18. The active tensioning device of claim 14, the male and female connecting members are configured such that the body and the fixation member are only connectable when the body is in the operative configuration.

19. The active tensioning device of claim 15, the male and female connecting members are configured such that the body and the fixation member are only connectable when the body is in the operative configuration.

20. The active tensioning device of claim 16, the male and female connecting members are configured such that the body and the fixation member are only connectable when the body is in the operative configuration.
